(19) United States
(12) Patent Application Publication
(10) Pub. No.: US 2025/0301493 A1
(43) Pub. Date: Sep. 25, 2025

(54) COMMUNICATION SYSTEM THAT PROVIDES VOICE CALLS

(71) Applicant: JVCKENWOOD Corporation, Yokohama-shi (JP)

(72) Inventor: Takahiro MISHINA, Yokohama-shi (JP)

(21) Appl. No.: 19/083,924

(22) Filed: Mar. 19, 2025

(30) Foreign Application Priority Data
Mar. 22, 2024 (JP) 2024-046007
Sep. 20, 2024 (JP) 2024-163848

(51) Int. Cl. H04W 72/54

(52) U.S. Cl. CPC H04W 72/54

(57) ABSTRACT

When a second terminal apparatus determines whether a voice call can be made based on a strength of a signal received from a second base station apparatus, the second terminal transmits a determination result to a server. The server manages the determination result as a reception status. A first terminal apparatus transmits a call request signal to the server. When the reception status indicates that a voice call can be made, the server transmits a call signal to the second terminal apparatus.

### CROSS-REFERENCE TO RELATED APPLICATION

This application is based upon and claims the benefit of priority from the prior Japanese Patent Application No. 2024-46007, filed on Mar. 22, 2024, and the prior Japanese Patent Application No. 2024-163848, filed on Sep. 20, 2024, the entire contents of which is incorporated herein by reference.

### BACKGROUND

### 1. Technical Field

The present disclosure relates to a communication technology and, particularly, to a communication system that provides voice calls.

### 2. Description of the Related Art

The PTT (Push to Talk) function is a function that provides users with the user-friendliness such as that of half-duplex radio equipment. The user can call and speak to multiple other users simply by pressing the call button without entering a phone number, etc. The other user does not need to press an answer button to cause the utterance content to be output from the user's mobile phone. The service of providing the PTT function in a mobile communication network is PoC (Push-to-Talk over Cellular) service (e.g., Patent Literature 1).

[Patent Literature 1] JP2008-527942

In PoC, a terminal apparatus (PoC terminal) set up by a PoC server for a session receives an audio signal, but, if the terminal apparatus is located near the fringe (in a weak electric field environment), the reception of an audio signal may fail, or a voice call cannot be made. Taking LTE (Long Term Evolution) communication systems as an example, the terminal equipment generally receives a reference signal (CRS (Cell-specific Reference Signal) communicated from the base station equipment, measures RSRP (Reference Signal Received Power) or RSRQ (Reference Signal Received Quality), and reports a measurement result to the base station apparatus. The base station apparatus terminates the RRC (Radio Resource Control) connection in the radio bearer from the terminal apparatus according to the measurement result. However, the mobile communication network maintains the EPS (Evolved Packet System) bearer of the core network even if the RRC connection is terminated. When a call (establishment of a session for a PoC call) from the transmitting terminal apparatus (hereinafter referred to as the “first terminal apparatus”) to the receiving terminal apparatus (hereinafter referred to as the “second terminal apparatus”) is attempted, therefore, the PoC server attempts to set a session in the second terminal apparatus. This process is performed even if a voice call cannot be made due to the presence of the second terminal apparatus near the fringe. As a result, useless traffic is generated when the receiving terminal apparatus cannot make a voice call.

### SUMMARY

A communication system according to an embodiment of the present disclosure includes: a first terminal apparatus and a second terminal that can make a voice call; a first base station apparatus capable of wireless communication with the first terminal apparatus; a second base station apparatus capable of wireless communication with the second terminal apparatus; a core network that connects the first base station apparatus and the second base station apparatus and sets a communication network for communication with each of the first terminal apparatus and the second terminal apparatus; and a server that is connected to the core network, manages a call with the first terminal apparatus and the second terminal apparatus, and manages a reception status in the second terminal apparatus in response to a signal from the second base station apparatus. When the second terminal apparatus determines whether a voice call can be made based on a strength of the signal received from the second base station apparatus, the second terminal transmits a determination result to the server. When the server receives the determination result from the second terminal apparatus, the server manages the determination result as the reception status. The first terminal apparatus transmits a call request signal to the server to start a call with the second terminal apparatus. When the reception status indicates that a voice call can be made, the server transmits a call signal to the second terminal apparatus via the core network and the second base station apparatus.

Another embodiment of the present disclosure relates to a communication system. The communication system includes: a first terminal apparatus and a second terminal that can make a voice call; a first base station apparatus capable of wireless communication with the first terminal apparatus; a second base station apparatus capable of wireless communication with the second terminal apparatus; a core network that connects the first base station apparatus and the second base station apparatus and sets a communication network for communication with each of the first terminal apparatus and the second terminal apparatus; and a server that is connected to the core network, manages a call with the first terminal apparatus and the second terminal apparatus, and manages a reception status in the second terminal apparatus in response to a signal from the second base station apparatus. The second terminal apparatus measures a strength of a signal received from the second base station apparatus and transmits information on the strength to the server. When the server receives the information on the strength from the second terminal apparatus, the server manages the information on the strength as the reception status. The first terminal apparatus transmits a call request signal to the server to start a call with the second terminal apparatus. When the reception status indicates a strength that makes a voice call possible, the server transmits a call signal to the second terminal apparatus via the core network and the second base station apparatus.

A communication system according to another embodiment of the present disclosure includes: a first terminal apparatus and a second terminal that can make a voice call; a first base station apparatus capable of wireless communication with the first terminal apparatus; a second base station apparatus capable of wireless communication with the second terminal apparatus; a core network that connects the first base station apparatus and the second base station apparatus and sets a communication network for communication with each of the first terminal apparatus and the second terminal apparatus; a first server that is connected to the core network and manages a call with the first terminal apparatus and the second terminal apparatus; and a second server that is connected to the core network and manages a reception status in the second terminal apparatus in response to a signal from the second base station apparatus. When the second terminal apparatus determines whether a voice call can be made based on a strength of the signal received from the second base station apparatus, the second terminal transmits a determination result to the second server. When the second server receives the determination result from the second terminal apparatus, the second server manages the determination result as the reception status. The first terminal apparatus transmits a call request signal to the first server to start a call with the second terminal apparatus. When the first server receives the call request signal from the first terminal apparatus, the first server acquires the reception state from the second server. When the reception status indicates that a voice call can be made, the first server transmits a call signal to the second terminal apparatus via the core network and the second base station apparatus.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a configuration of the communication system according to the embodiment;

FIG. 2 shows a configuration of the terminal apparatus of FIG. 1;

FIG. 3 shows the configuration of the first server of FIG. 1;

FIG. 4 is a flowchart showing steps for reporting performed by the second terminal apparatus of FIG. 1; and

FIG. 5 is a flowchart showing steps of a process performed by the first server of FIG. 1.

### DETAILED DESCRIPTION

The invention will now be described by reference to the preferred embodiments. This does not intend to limit the scope of the present invention, but to exemplify the invention.

A summary will be given before describing the embodiment in specific details. The embodiment relates to a communication system for executing PoC. In the communication system, the first terminal apparatus and the second terminal apparatus are connected to the core network, and an EPS bearer is set in the core network. Further, the first server, which is the PoC server described above, is connected to the core network. The second terminal apparatus determines whether a voice call can be made based on the strength of a signal received from the base station apparatus and transmits a determination result to the second server connected to the core network. The second server stores the received determination result as the reception status of the second terminal apparatus.

In this situation, the first terminal apparatus transmits a call request signal to the first server to request a start of a voice call with the second terminal apparatus. When the first server receives the call request signal, the first server acquires the reception status of the second terminal apparatus from the second server. When the reception status of the second terminal apparatus indicates that a call can be made, the first server transmits a call signal to the second terminal apparatus using an EPS bearer. As the second terminal apparatus responds to the call signal, a voice call is made between the first terminal apparatus and the second terminal apparatus. When the reception status of the second terminal apparatus indicates that a call cannot be made, on the other hand, the first server does not transmit a call signal to the second terminal apparatus. That is, generation of unnecessary traffic from the first server to the second terminal apparatus is suppressed by determining, in the first server, whether to make a POC voice call.

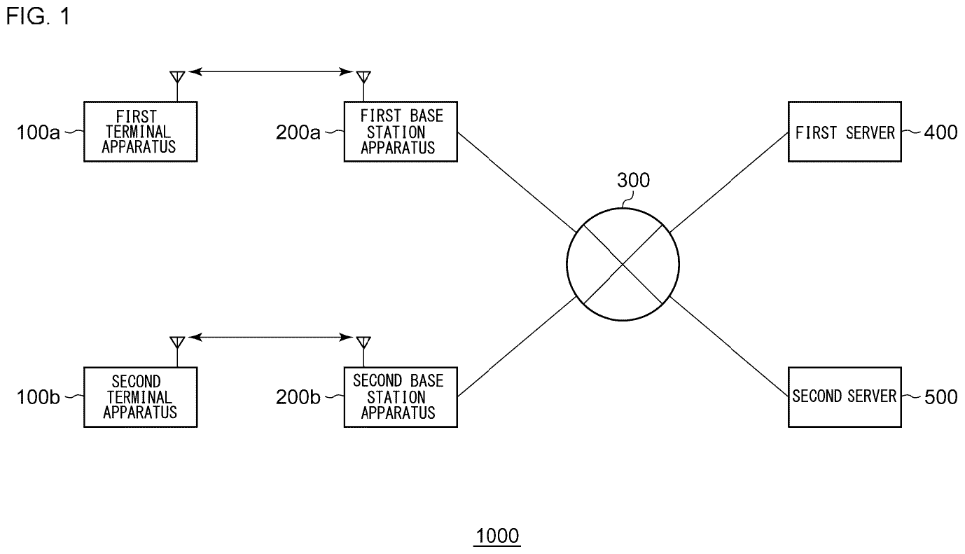

FIG. 1 shows a configuration of the communication system 1000. The communication system 1000 includes a first terminal apparatus 100a, a second terminal apparatus 100b, which are collectively referred to as the terminal apparatus 100, a first base station apparatus 200a, a second base station apparatus 200b, which are collectively referred to as the base station apparatus 200, a core network 300, a first server 400, and a second server 500. The number of terminal apparatuses 100 and the base station apparatuses 200 included in the communication system 1000 is not limited to “2”.

The communication system 1000 is, for example, a PoC system that uses the data communication function of a mobile communication system such as LTE (Long Term Evolution) and 5G. The first terminal apparatus 100a is a wireless communication device used by a user (hereinafter also referred to as a “first user”) and communicates with the first base station apparatus 200a by a wireless communication scheme for mobile communication. The second terminal apparatus 100b is a wireless communication device used by a user (hereinafter also referred to as a “second user”) and communicates with the second base station apparatus 200b by a wireless communication scheme for mobile communication. In this case, it is assumed that the first terminal apparatus 100a is the transmitting terminal apparatus 100, the second terminal apparatus 100b is the receiving terminal apparatus 100, and the first terminal apparatus 100a and the second terminal apparatus 100b make a voice call.

The first base station apparatus 200a is a base station apparatus 200 capable of wireless communication with the first terminal apparatus 100a and is also connected to the core network 300. The second base station apparatus 200b is a base station apparatus 200 capable of wireless communication with the second terminal apparatus 100b and is also connected to the core network 300. In this case, the first terminal apparatus 100a and the second terminal apparatus 100b are connected to different base station apparatuses 200 by way of example, but the first terminal apparatus 100a and the second terminal apparatus 100b may be connected to the same base station apparatus 200.

The core network 300 is a mobile communication system network that connects the first base station apparatus 200a and the second base station apparatus 200b. In LTE, the core network 300 is referred to as EPC (Evelved Packet Core) and sets an EPS bearer for each of the first terminal apparatus 100a and the second terminal apparatus 100b. In 5G, the core network 300 is referred to as 5GC (5th Generation Core Network) and sets a PDU (Protocol Data Unit) session with each of the first terminal apparatus 100a and the second terminal apparatus 100b. Since a known technique may be used to set the EPS bearer and the PDU session in the core network 300, a description thereof is omitted here. Hereinafter, a description will be given on an assumption that the communication scheme is LTE.

The first server 400 is connected to the core network 300 and manages calls between the first terminal apparatus 100a and the second terminal apparatus 100b. Further, the first server 400 manages the account of each terminal apparatus 100 and controls PoC voice calls.

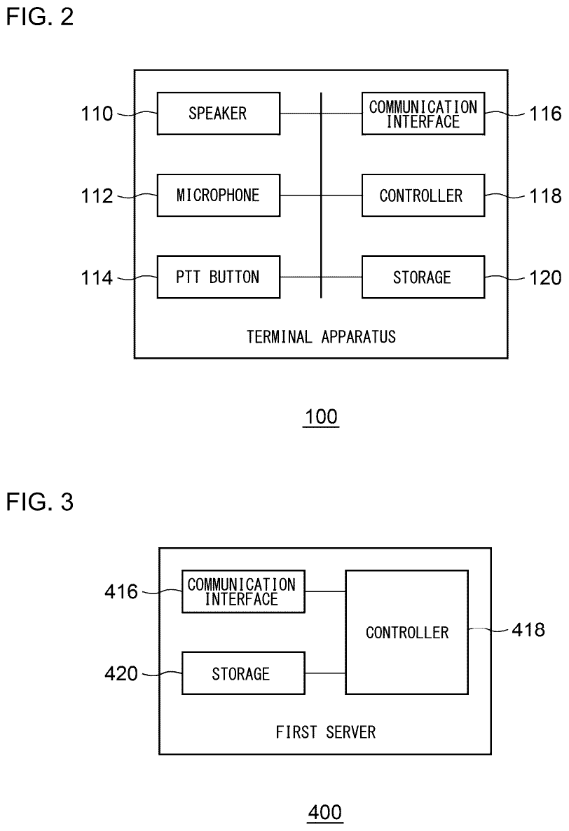

Hereinafter, the process for establishing a voice call by PoC in this communication system 1000 will be described with reference also to FIG. 2 and FIG. 3. FIG. 2 shows a configuration of the terminal apparatus 100. The terminal apparatus 100 includes a speaker 110, a microphone 112, a PTT button 114, a communication interface 116, a controller 118, and a storage 120. The first terminal apparatus 100a and the second terminal apparatus 100b of FIG. 1 have the same configuration.

The communication interface 116 executes wireless communication corresponding to the aforementioned mobile communication system and communicates with the base station apparatus 200. The operation of the communication interface 116 is controlled by the controller 118. The storage 120 stores information used in wireless communication or PoC calls in the communication interface 116. For example, the storage 120 stores address information on the terminal apparatus 100, address information on a further terminal apparatus 100 as the destination, etc. Further, the storage 120 also stores a threshold value that should be compared with the signal strength. The threshold value may be set by the user.

The PTT button 114 is a button that can be pressed down by the user. This can be said to be an interface manipulated by the user using the terminal apparatus 100. The PTT button 114 outputs the received user control to the controller 118. When the PTT button 114 is pressed down, the communication interface 116 can transmit an audio signal. When the PTT button 114 is not pressed down, on the other hand, the communication interface 116 can receive an audio signal.

The microphone 112 acquires the voice generated by the user when the user is pressing down the PTT button 114. The microphone 112 converts the acquired voice into an electrical signal and outputs the converted voice (hereinafter referred to as “audio signal”) to the controller 118. When the user is not pressing down the PTT button, the controller 118 receives the audio signal from the communication interface 116, converts the audio signal into a voice, and outputs the voice from the speaker 110.

When the power supply of the second terminal apparatus 100b is turned on, the controller 118 causes the communication interface 116 to transmit a signal for requesting connection with the core network 300 (hereinafter referred to as a “connection request signal”). When the second base station apparatus 200b receives the connection request signal, the second base station apparatus 200b transmits the connection request signal to the core network 300. The core network 300 executes authentication of the second terminal apparatus 100b based on the connection request signal. When the authentication is completed, the core network 300 transmits a signal (hereinafter referred to as the “completion report signal”) for indicating the completion of authentication to the second terminal apparatus 100b via the second base station apparatus 200b.

The communication interface 116 of the second terminal apparatus 100b receives the completion report signal from the core network 300. The controller 118 recognizes the completion of authentication with the core network 300 by receiving the completion report signal in the communication interface 116. Further, the second terminal apparatus 100b executes PoC account authentication with the first server, and the communication interface 116 receives account information from the first server 400. The controller 118 stores the account information received by the communication interface 116 in the storage 120.

When the communication interface 116 receives a signal (e.g., a reference signal) from the second base station apparatus 200b, the communication interface 116 measures the strength of the signal. Specifically, the strength of the signal may be measured by using CRS (Common Reference Signal) in the case of LTE and CSI-RS (Channel State Information Reference Signal) in the case of 5G. The method of measuring the strength of the signal is not limited to this, and other signals may be used. The controller 118 compares the strength of the signal received from the communication interface 116 with the threshold value stored in the storage 120. The controller 118 determines that a voice call can be made when the strength of the signal is larger than the threshold value. On the other hand, the controller 118 determines that a voice call cannot be made when the strength of the signal is equal to or smaller than the threshold value. The controller 118 outputs a determination result indicating that a voice call can be made or a voice call cannot be made to the communication interface 116. The communication interface 116 transmits the determination result to the second server 500 via the second base station apparatus 200b and the core network 300.

The second server 500 is connected to the core network 300 and receives the determination result from the second terminal apparatus 100b via the second base station apparatus 200b and the core network 300. The second server 500 manages the determination result from the second terminal apparatus 100b. The determination result from the second terminal apparatus 100b can be said to be the reception status in the second terminal apparatus 100b in response to the signal from the second base station apparatus 200b. The operation described so far is also executed in the first terminal apparatus 100a.

When the first user of the first terminal apparatus 100a executes a call with the second user of the second terminal apparatus 100b, the first user presses down the PTT button 114 of the first terminal apparatus 100a. In this process, the second terminal apparatus 100b as the destination is selected according to the user control by the first user. The controller 118 receives a request to start a call in response to the PTT button 114 being pressed down. When the controller 118 receives the request to start a call, the controller 118 generates a call request signal. The call request signal includes the address information om the first terminal apparatus 100a, the account information on the second terminal apparatus 100b as destination, and a request to establish a session for voice communication between the first terminal apparatus 100a and the first server 400. The call request signal is a signal for requesting a start of a call with the second terminal apparatus 100b. The communication interface 116 transmits the call request signal to the first server 400 via the first base station apparatus 200a and the core network 300.

FIG. 3 shows the configuration of the first server 400. The first server 400 includes a communication interface 416, a controller 418, and a storage 420. The communication interface 416 receives the call request signal from the first terminal apparatus 100a via the first base station apparatus 200a and the core network 300. The controller 418 sets a session with the first terminal apparatus 100a based on the address information and the account information on the first terminal apparatus 100a in the received call request signal. Further, the controller 418 extracts the account information on the second terminal apparatus 100b as the destination from the received call request signal. The controller 418 generates a signal for inquiring about the reception status of the second terminal apparatus 100b (hereinafter referred to as “inquiry signal”) and outputs the inquiry signal to the communication interface 416. The inquiry signal also includes the address information on the second terminal apparatus 100b. The communication interface 416 transmits the inquiry signal to the second server 500.

The second server 500 receives the inquiry signal from the first server 400. The second server 500 acquires the address information on the second terminal apparatus 100b included in the inquiry signal. The second server 500 extracts the reception status of the second terminal apparatus 100b corresponding to the acquired address information and transmits a signal (hereinafter referred to as “response signal”) including the reception status of the second terminal apparatus 100b to the first server 400.

The communication interface 416 of the first server 400 receives the response signal from the second server 500. The controller 418 acquires the reception status of the second terminal apparatus 100b included in the response signal. The controller 418 generates a call signal when the reception status indicates that a voice call can be made. The call signal includes the address information on the first terminal apparatus 100a as the transmission source and the account information on the second terminal apparatus 100b as the destination. The communication interface 416 transmits a call signal to the second terminal apparatus 100b via the core network 300 and the second base station apparatus 200b using an EPS bearer with the second terminal apparatus 100b. In this process, the controller 418 sets a session with the second terminal apparatus 100b. Thereby, a call involving transmission and reception of an audio signal is executed between the first terminal apparatus 100a and the second terminal apparatus 100b. A known technique may be used for this.

When the reception status indicates that a voice call cannot be made, on the other hand, the controller 418 does not generate a call signal, and the communication interface 416 does not transmit a call signal to the second terminal apparatus 100b. As a result, no calls are executed between the first terminal apparatus 100a and the second terminal apparatus 100b. Further, the controller 418 may store the audio signal from the first terminal apparatus 100a.

The features are implemented in hardware such as a CPU, a memory, or other LSI's, of any computer and in software such as a program loaded into a memory. The figure depicts functional blocks implemented by the cooperation of these elements. Therefore, it will be understood by those skilled in the art that the functional blocks may be implemented in a variety of manners by hardware only, software only, or by a combination of hardware and software.

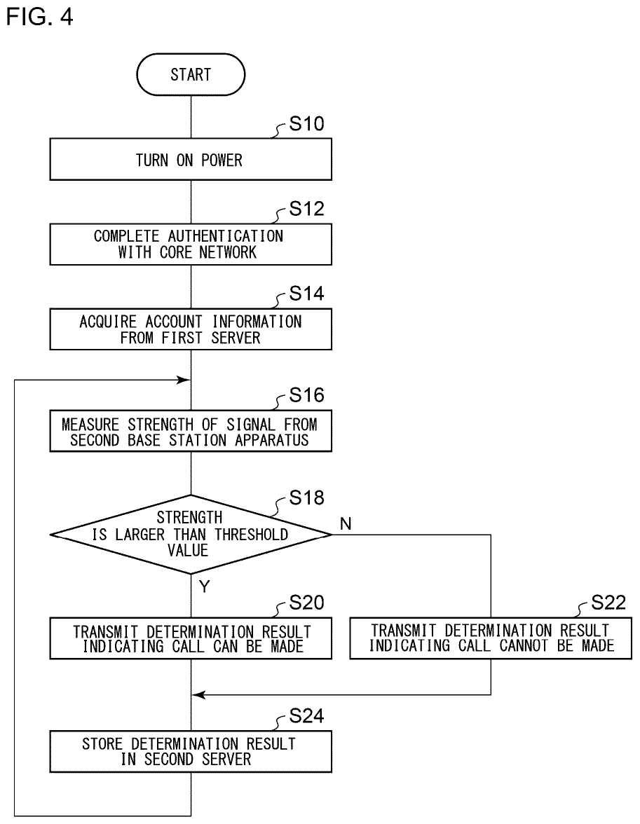

The operation of the communication system 1000 according to the above configuration will be described. FIG. 4 is a flowchart showing steps for reporting performed by the second terminal apparatus 100b. The power is turned on (S10). The controller 118 receives a notification of completion of authentication with the core network 300 via the communication interface 116 (S12). The controller 118 acquires the account information from the first server 400 via the communication interface 116 (S14). The communication interface 116 measures the strength of the signal from the second base station apparatus 200b (S16). When the strength is larger than the threshold value (Y in S18), the communication interface 116 transmits the determination result indicating that a call can be made (S20). When the strength is not larger than the threshold value (N of S18), on the other hand, the communication interface 116 transmits the determination result indicating that a call cannot be made (S22). The determination result is stored in the second server 500 (S24). Control then returns to step S16, and steps S16 to S24 are repeated subsequently. When the determination result of step S18 is the same as previous, transmission of the determination result may be omitted.

In step S18, the determination result may be transmitted either when the strength of the signal from the second base station apparatus 200b is larger than the threshold value or when the strength is not larger. In this case, only the unique ID of the second terminal apparatus 100b may be transmitted as the determination result. In the case, for example, the unique ID of the second terminal apparatus 100b is configured to be transmitted when the strength of communication from the second base station apparatus 200b is larger than the threshold value, the second server 500 stores the determination result indicating that the second terminal apparatus 100b can communicate when the unique ID of the second terminal apparatus 100b is received and stores the determination result indicating that the second terminal apparatus 100b cannot communicate with the unique ID of the second terminal apparatus 100b is not received. In the case the unique ID of the second terminal apparatus 100b is configured to be transmitted when the strength with respect to the second base station apparatus 200b is not larger than the threshold value, the second server 500 stores the determination result indicating that the second terminal apparatus 100b cannot communicate when the unique ID of the second terminal apparatus 100b is received and stores the determination result indicating that the second terminal apparatus 100b can communicate with the unique ID of the second terminal apparatus 100b is not received. In the case the determination result is transmitted either when the strength of the signal from the second base station apparatus 200b is larger than the threshold value or when the strength is not larger, it is desirable to assume a case in which the second terminal apparatus 100b and the second base station apparatus 200b cannot communicate at all and to transmit the determination result when the strength of communication from the second base station apparatus 200b is larger than the threshold value.

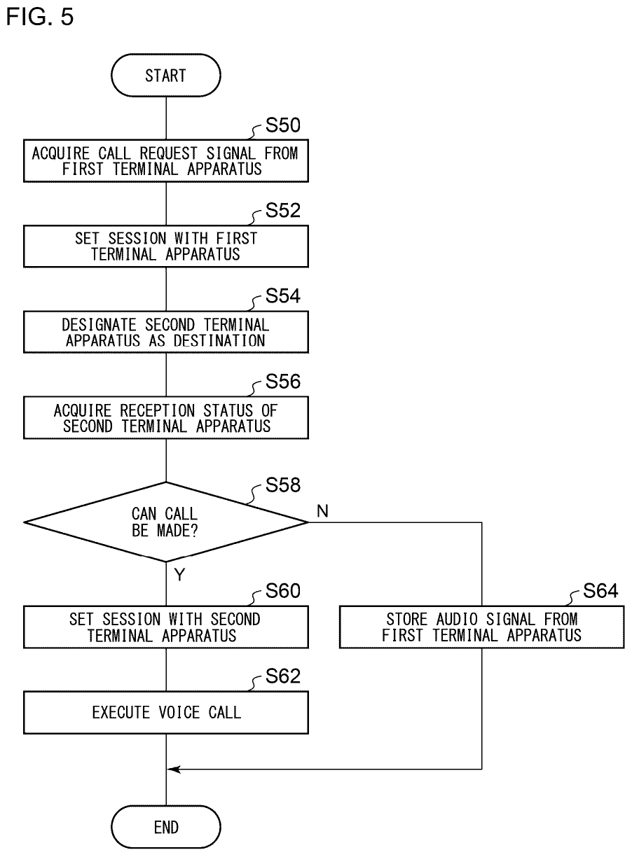

FIG. 5 is a flowchart showing steps of a process performed by the first server 400. The communication interface 416 receives a call request signal from the first terminal apparatus 100a (S50). The controller 418 sets a session with the first terminal apparatus 100a (S52). The controller 418 designates the second terminal apparatus 100b as the destination (S54). The controller 418 acquires the reception status of the second terminal apparatus 100b from the second server 500 via the communication interface 416 (S56). When a call can be made (Y in S58), the controller 418 sets a session with the second terminal apparatus 100b (S60). As a result, a voice call between the first terminal apparatus 100a and the second terminal apparatus 100b is executed (S62). When a call cannot be made (N in S58), on the other hand, the controller 418 stores the audio signal from the first terminal apparatus 100a (S64).

### Variation

It has been described so far that the determination result reflecting whether a call can be made in each terminal apparatus 100 is transmitted to the second server 500. In the variation, on the other hand, a determination as to whether a call can be made is made in the first server 400. The communication system 1000, the terminal apparatus 100, and the first server 400 according to the variation are of the same type as those of FIGS. 1 to 3. A description will be given of the difference from the foregoing embodiment.

When the communication interface 116 of the second terminal apparatus 100b receives a signal such as a reference signal (CRS) from the second base station apparatus 200b, the communication interface 116 measures the strength of the signal. The controller 118 generates a signal (hereinafter referred to as “strength information”) that includes the strength of the signal received from the communication interface 116 and outputs the strength information to the communication interface 116. The communication interface 116 transmits the strength information to the second server 500 via the second base station apparatus 200b and the core network 300.

The second server 500 receives the strength information from the second terminal apparatus 100b via the second base station apparatus 200b and the core network 300. The second server 500 manages the strength information from the second terminal apparatus 100b. The strength information from the second terminal apparatus 100b can be said to be the reception status of the second terminal apparatus 100b in response to the signal from the second base station apparatus 200b. This operation is also executed in the first terminal apparatus 100a.

The communication interface 416 of the first server 400 receives the call request signal from the first terminal apparatus 100a via the first base station apparatus 200a and the core network 300. The controller 418 sets a session with the first terminal apparatus 100a based on the address information and the account information on the first terminal apparatus 100a in the received call request signal. Further, the controller 418 extracts the account information on the second terminal apparatus 100b as the destination from the received call request signal. The controller 418 generates an inquiry signal to inquire about the reception status of the second terminal apparatus 100b and outputs the inquiry signal to the communication interface 416. The inquiry signal also includes the address information on the second terminal apparatus 100b. The communication interface 416 transmits the inquiry signal to the second server 500.

The second server 500 receives the inquiry signal from the first server 400. The second server 500 acquires the address information on the second terminal apparatus 100b included in the inquiry signal. The second server 500 extracts the reception status of the second terminal apparatus 100b corresponding to the acquired address information and transmits a response signal including the reception status of the second terminal apparatus 100b to the first server 400.

The communication interface 416 of the first server 400 receives the response signal from the second server 500. The controller 418 acquires the reception status, i.e., the strength information, of the second terminal apparatus 100b included in the response signal. The controller 418 compares the acquired strength information with the threshold value stored in the storage 420. The controller 418 generates a call signal when the strength information is larger than the threshold, i.e., when the reception status indicates a strength that makes a voice call possible. The call signal includes the address information on the first terminal apparatus 100a as the transmission source and the address information on the second terminal apparatus 100b as the destination. The communication interface 416 transmits the call signal to the second terminal apparatus 100b via the core network 300 and the second base station apparatus 200b using an EPS bearer with the second terminal apparatus 100b. In that process, the controller 418 sets a session with the second terminal apparatus 100b. Thereby, a call involving transmission and reception of an audio signal is executed between the first terminal apparatus 100a and the second terminal apparatus 100b. A known technique may be used for this.

When the strength information is equal to or smaller than the threshold value, i.e., when the reception status indicates a strength that makes a voice call impossible, on the other hand, the controller 418 does not generate a call signal, and the communication interface 416 does not transmit a call signal to the second terminal apparatus 100b. As a result, no calls are executed between the first terminal apparatus 100a and the second terminal apparatus 100b. Further, the controller 418 may store the audio signal from the first terminal apparatus 100a.

According to this embodiment, even if an EPS bearer with the receiving terminal apparatus 100 is set, the first server 400 does not transmit a call signal to the receiving terminal apparatus 100 when it is determined that a call cannot be made in the receiving terminal apparatus 100. Accordingly, unnecessary traffic is suppressed in the case the receiving terminal apparatus cannot make a voice call. Further, even if an EPS bearer with the receiving terminal apparatus 100 is set, the first server 400 does not transmit a call signal to the receiving terminal apparatus 100 in the case the strength of the signal in the receiving terminal apparatus 100 makes a call impossible. Accordingly, unnecessary traffic is suppressed in the case the receiving terminal apparatus cannot make a voice call. Further, the first base station apparatus 200a and the second base station apparatus 200b are of the same configuration so that flexibility of the configuration can be improved.

The present disclosure has been described above based on an exemplary embodiment. While audio signals have been described in the embodiment, the embodiment is not limited to this and is applicable to information signals such as data signals. The embodiment is intended to be illustrative only and it will be understood by those skilled in the art that various modifications to constituting elements and processes could be developed and that such modifications are also within the scope of the present disclosure.

In the above embodiment, the first server and the second server have been described as separate entities. Alternatively, the functions of the first server and the second server may be provided in one server. Further, the functions of the first server and the second server may be distributed among a plurality of servers.

What is claimed is:

1. A communication system comprising:
a first terminal apparatus and a second terminal that can make a voice call;
a first base station apparatus capable of wireless communication with the first terminal apparatus;
a second base station apparatus capable of wireless communication with the second terminal apparatus;
a core network that connects the first base station apparatus and the second base station apparatus and sets a communication network for communication with each of the first terminal apparatus and the second terminal apparatus; and
a server that is connected to the core network, manages a call with the first terminal apparatus and the second terminal apparatus, and manages a reception status in the second terminal apparatus in response to a signal from the second base station apparatus;
wherein, when the second terminal apparatus determines whether a voice call can be made based on a strength of the signal received from the second base station apparatus, the second terminal transmits a determination result to the server,
wherein, when the server receives the determination result from the second terminal apparatus, the server manages the determination result as the reception status;
wherein the first terminal apparatus transmits a call request signal to the server to start a call with the second terminal apparatus, and
wherein, when the reception status indicates that a voice call can be made, the server transmits a call signal to the second terminal apparatus via the core network and the second base station apparatus.

2. The communication system according to claim 1;
wherein the second terminal apparatus includes:
a storage that stores a threshold value of signal strength;
a communication interface that measures the strength of the signal from the second base station apparatus; and
a controller that compares the strength of the signal measured by the communication interface with the threshold of signal strength, determines that a voice call can be made when the strength of the signal is larger than the threshold value, and determines that a voice call cannot be made when the strength of the signal is equal to or smaller than the threshold value.

3. A communication system comprising:
a first terminal apparatus and a second terminal that can make a voice call;
a first base station apparatus capable of wireless communication with the first terminal apparatus;
a second base station apparatus capable of wireless communication with the second terminal apparatus;
a core network that connects the first base station apparatus and the second base station apparatus and sets a communication network for communication with each of the first terminal apparatus and the second terminal apparatus; and
a server that is connected to the core network, manages a call with the first terminal apparatus and the second terminal apparatus, and manages a reception status in the second terminal apparatus in response to a signal from the second base station apparatus,
wherein the second terminal apparatus measures a strength of a signal received from the second base station apparatus and transmits information on the strength to the server,
wherein, when the server receives the information on the strength from the second terminal apparatus, the server manages the information on the strength as the reception status,
wherein the first terminal apparatus transmits a call request signal to the server to start a call with the second terminal apparatus, and
wherein, when the reception status indicates a strength that makes a voice call possible, the server transmits a call signal to the second terminal apparatus via the core network and the second base station apparatus.

4. A communication system comprising:
a first terminal apparatus and a second terminal that can make a voice call;
a first base station apparatus capable of wireless communication with the first terminal apparatus;
a second base station apparatus capable of wireless communication with the second terminal apparatus;
a core network that connects the first base station apparatus and the second base station apparatus and sets a communication network for communication with each of the first terminal apparatus and the second terminal apparatus;
a first server that is connected to the core network and manages a call with the first terminal apparatus and the second terminal apparatus; and
a second server that is connected to the core network and manages a reception status in the second terminal apparatus in response to a signal from the second base station apparatus,
wherein, when the second terminal apparatus determines whether a voice call can be made based on a strength of the signal received from the second base station apparatus, the second terminal transmits a determination result to the second server,
wherein, when the second server receives the determination result from the second terminal apparatus, the second server manages the determination result as the reception status,
wherein the first terminal apparatus transmits a call request signal to the first server to start a call with the second terminal apparatus,
wherein, when the first server receives the call request signal from the first terminal apparatus, the first server acquires the reception state from the second server, and
wherein, when the reception status indicates that a voice call can be made, the first server transmits a call signal to the second terminal apparatus via the core network and the second base station apparatus.
